(19) United States
(12) Patent Application Publication
(10) Pub. No.: US 2003/0192641 A1
(43) Pub. Date: Oct. 16, 2003

(54) Method and apparatus of assembling a fluid flow conduit assembly of dissimilar plastics

(76) Inventor: Gilbert-Bobby A. Espejo, Dumont, NJ (US)

Correspondence Address: CLIFFORD G. FRAYNE, Suite 7A, 136 Drum Point Road, Brick, NJ, 08723, US

(21) Appl. No.: 10/378,134

(22) Filed: Mar. 4, 2003

Related U.S. Application Data
(60) Provisional application No. 60/372,368, filed on Apr. 15, 2002.

(51) Int. Cl. B32B 31/00

(52) U.S. Cl. 156/272.4; 156/293; 156/379.7

(57) ABSTRACT

A method for forming a fluid conduit system between a first conduit member fabricated from a first type of plastic and a second conduit member of dissimilar plastic, the second conduit member including a coupling element having a filleted inner surface, the method including slidably positioning a compression ring proximate the end of the first conduit member and positioning a bonding layer of electromagnetically activated adhesive bonding composition about the end of the first conduit member and positioning the end of the first conduit member in the coupling member and subjecting it to electromagnetic energy so as to soften the bonding composition and end of the first conduit member while pressing the first conduit member into the coupling and then pressing the compression ring into the coupling and discontinuing the application of electromagnetic energy.

### RELATED APPLICATINS

Applicant claims the benefit of provisional application 60/372,368 filed Apr. 15, 2002.

### BACKGROUND OF THE INVENTION

1. Field of the Invention

The present invention relates to fluid flow conduit assemblies and methods of assembling same, and more particularly to conduit assemblies in which the tubing plastic is dissimilar from the plastic member to which it is to be attached, such as a joint, reservoir or manifold.

2. Description of the Prior Art

Plastic is rapidly replacing metals commonly used in many commercial applications. Plastic can present a cost savings, a weight savings, and in many instances, increased durability. Manufacturers of appliances are beginning to specify plastic tubes fabricated of cross linked polyethylene. The cross linked polyethylene (PEX) offers durability within a wide range of temperatures, pressures and chemicals. However, the cross linked polyethylene tubing is more often than not required to be secured to manifold joints or other plastic members within the appliances which are constructed of a different type of plastic material such as ABS. The method of attachment has presently been addressed in one of several manners. One method utilizes mechanical tube fittings threaded into place using compression seals, however, this is labor intensive and the cost of threaded parts and seals also increase the expense. Another method which addresses the problem is the use of crimping rings which require special crimping tools which are ineffective for mass production. Another attempt to address the problem utilized ultrasonic welding of a retainer ring to compress a tube end with special barbed ends in a manifold or part. However, this method requires an O-ring to create the seal and the fabrication of barbed ends on the tubing and retainer rings assembled in place.

Applicant's invention provides for an economical, cost effective and time efficient manner of securing cross linked, polyethylene tubing to plastic members such as joints, manifolds or the like which are constructed of a dissimilar plastic material such as ABS.

### OBJECTS OF THE INVENTION

An object of the present invention is to provide for a novel plastic conduit assembly in which a conduit of one plastic material is secured to a conduit or part fabricated of a dissimilar plastic material.

A further object of the present invention is to provide for a novel plastic conduit assembly in which a conduit of one plastic material is secured to a conduit, manifold or part fabricated of a dissimilar plastic material in a time efficient and economical manner.

A still further object of the present invention is to provide for a method of securing a plastic conduit fabricated of one type of plastic to a conduit manifold, connector, or the like, fabricated of a dissimilar plastic.

### SUMMARY OF THE INVENTION

The end of the plastic conduit to be secured is fitted with a slidable compression ring and a gasket of electromagnetically activated adhesive bonding composition and the end of the conduit and bonding gasket is positioned in the coupling element and is heated to its softening temperature by an inductive electromagnetic field of the type described in U.S. Pat. No. 3,620,875, the end of the conduit with bonding gasket is then pressed into the coupling element, the coupling element having a receiving receptacle which has a fillet feature. The conduit flares at its heated end and conforms to the filleted surface of the coupling element. Thereafter a compression ring is pressed into the receiving receptacle and the melted thermoplastic bonding material is pressure formed on the inside of the coupling element thereby securing the conduit end in place at the same time the compression ring is bonded to the coupling element with the thermoplastic bonding material. The result is a combination of a strong mechanical and hermetic seal at the joint interface between the conduit and the coupling element.

### BRIEF DESCRIPTION OF THE DRAWINGS

These and other objects of the present invention will become evident particularly when taken in light of the following illustrations wherein:

FIG. 1 is a cross-sectional view of the end of a conduit constructed of one type of plastic material, and a manifold or coupling element of a dissimilar plastic material to which the conduit must be mechanically secured and sealed; and

FIG. 2 is a cross-sectional view of FIG. 1 illustrating the conduit and coupling element undergoing mechanical connection and sealing; and

FIG. 3 is a cross-sectional view of FIG. 1 illustrating the completed mechanical connection and seal as accomplished by Applicant's method.

### DETAILED DESCRIPTION OF THE INVENTION

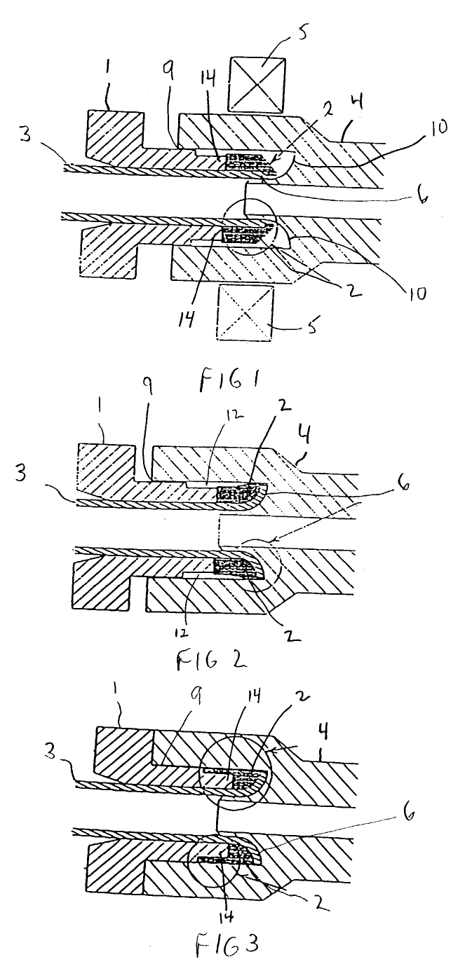

Referring to FIGS. 1, 2 and 3 there is illustrated a cross-sectional view of an end of a conduit of plastic tubing 3 constructed or fabricated from cross linked polyethylene which must be mechanically secured and sealed with respect to a coupling element 4 of dissimilar plastic secured to a manifold reservoir or the like. FIGS. 1, 2 and 3 are illustrative of the steps to achieve the secure connection. This mechanical connection and hermetic sealing is accomplished by positioning a compression ring 1 slidably received about the tubing 3, and thereafter positioning a thermoplastic bonding material 2 in the form of a slidably receivable gasket about the end 6 of tubing 3. The thermoplastic bonding material 2 is that which is described in U.S. Pat. No. 3,620,875, which is incorporated by reference.

Once the compression ring 1 and the thermoplastic bonding gasket 2 are in position proximate the end 6 of tubing 3, tubing 3 and the thermoplastic bonding gasket 2 are inserted into the receiving receptacle 9 of coupling element 4. The heating of the thermoplastic bonding gasket 2 and the tubing 3 is accomplished by means of a work coil 5 positioned about the part or manifold 4. Thermoplastic bonding gasket 2 heats up as a result of the RF introduced by coil 5 and softens the end 6 of tubing 3. Pressure is brought to bear on tubing 3 and the softened tube end 6 of tubing 3 is forced to flare outwardly to conform to the shape of the fillet 10 in the receiving receptacle 9 (See FIG. 2). At this point pressure is applied to the compression ring 1 to engage receiving receptacle 9 which compresses the molten thermoplastic bonding gasket 2 into the void 12 between the coupling element 4, the flared ends of tubing 3, and the end 14 of the compression ring 1. The thermoplastic bonding gasket 2 sets upon cooling forming a mechanical connection between the coupling element 4, the compression ring 1 and the tubing 3 (See FIG. 3). Not only is the mechanical seal accomplished, but also the hermetic seal with respect to any fluids passing between the part and the tubing or vice versa.

The amount of electromagnetic energy absorbing material is at least 60 percent to about 76 percent by weight of the gasket member and is of a material selected from the group consisting of iron, cobalt, nickel, alloys containing nickel, alloys containing cobalt, and alloys containing iron.

The inductive heating effect is continued to the joint for a time period of from about 1.5 to 4.0 seconds with substantial savings of power and with avoidance of distortion to the articles being secured.

While a circular shaped coupling member and end portion is disclosed, it is understood to one skilled in the art that other shapes, such as an eliptically-shaped coupling member and end portion of the conduit may be used in accordance with the present invention.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

What is claimed:

1. A method for forming fluid conduit systems between a first conduit member fabricated of a first type of plastic, said first conduit member having an end portion and a second conduit member of dissimilar plastic from said first conduit member, said second conduit member including a coupling element having a filleted inner surface which method comprises:
slidably positioning a compression ring on said first conduit member;
positioning a bonding layer of electromagnetically activated adhesive bonding composition positioned about said end portion of said first conduit member, said end portion of said first conduit member being of a smaller dimension than said coupling element of said second conduit member, said bonding layer of said electromagnetically-activated adhesive bonding composition having uniformly distributed electromagnetic energy absorbing particles within a thermoplastic material;
positioning said end portion of said first conduit member into said coupling member of said second conduit member;
subjecting said first conduit member, said second conduit member and said bonding layer to an electromagnetic field of sufficient power and frequency to inductively heat said electromagnetically energy absorbing particles whereby said thermal plastic material of said bonding layer and said end portion of said first conduit member are heated proximate their melting points;
compressively forcing said first conduit into said coupling element and flaring said end of said first conduit outwardly conforming to said filleted surface;
sliding said compression toward said end of said first conduit member engaging said coupling element and said bonding layer;
terminating said electromagnetic field after melting and prior to material degradation to affect bonding of said first conduit member, said coupling element of said second conduit member, and said compression ring.

2. The method in accordance with claim 1 wherein said electromagnetic energy absorbing particles comprise at least 60 percent by weight of said electromagnetically activated adhesive bonding composition.

3. The method as defined in claim 2 wherein said electromagnetic field has a field intensity of about 1 to about 30 kilowatts and a frequency of about 2 to about 30 megacycles.

4. The method as defined in claim 1 wherein said coupling element of said rigid thermoplastic vessel and said end portion of said flexible elastomeric conduit are cylindrically-shaped, said should portion of said coupling element having an outer diameter smaller than an outer diameter of said coupling element, said end portion of flexible thermoset elastomeric conduit having an inner diameter smaller than said outer diameter of said coupling member.

5. The method in accordance with claim 1 wherein said filleted surface is J-shaped.

6. The method in accordance with claim 1 wherein said first conduit member is fabricated of cross linked polyethylene.

7. Apparatus for securing two plastic conduit members of dissimilar plastic together, said apparatus comprising:
a first tubular conduit member fabricated of a flexible plastic;
a second conduit member having a coupling formed thereon, said second conduit member and said coupling fabricated from a plastic dissimilar from said first conduit member, said coupling formed with a fillet inner surface;
a compression ring slidably positioned about said first tubular conduit;
a thermoplastic bonding gasket formed about an end of said first tubular conduit member;
a coil, selectively producing an electromagnetic field, said coil positioned about said end of said first tubular conduit member and said coupling to melt said thermoplastic bonding gasket and heat said end of said first tubular member, said first tubular member and said thermoplastic bonding gasket being pressed into said coupling and said fillet surface flaring said end of said first tubular conduit outwardly, said compression ring slidably inserted into said coupling forming a seal.
